(19) United States
(12) Patent Application Publication
(10) Pub. No.: US 2002/0177367 A1
(43) Pub. Date: Nov. 28, 2002

(54) RJ modular connector having printed circuit board having conductive trace to balance electrical couplings between terminals

(76) Inventor: James Hyland, Hummelstown, PA (US)

Correspondence Address: WEI TE CHUNG, FOXCONN INTERNATIONAL, INC., 1650 MEMOREX DRIVE, SANTA CLARA, CA, 95050, US

(21) Appl. No.: 10/037,706

(22) Filed: Dec. 29, 2001

Related U.S. Application Data
(63) Continuation-in-part of application No. 09/863,942, filed on May 22, 2001, now Pat. No. 6,413,121.

(51) Int. Cl. H01R 24/00

(52) U.S. Cl. 439/676

(57) ABSTRACT

A RJ modular connector (1) includes a housing (10) defining a plug receiving section, and a terminal core receiving section. A terminal core is (20) received in the terminal core receiving section and includes a number of terminals. A first and a second substrates (31, 41) are provided having a first and a second conductive traces thereon, respectively. The terminals are securely mounted onto the substrates. An electrical connection is established between a first and a second terminals and the first and second conductive traces, respectively, and portions of the conductive traces are arranged to create a first and a second electrical couplings between the first and a third terminals and the second and a fourth terminals. The third and the fourth terminals are arranged between the first and the second terminals and are located close to each other but far from the first and the second terminals, respectively.

This is a continuation-in-part of the copending application Ser. No. 09/863,942 filed

### on May 22, 2001.

### BACKGROUND OF THE INVENTION

1. Field of the Invention

The present invention relates to a RJ modular connector, and more particularly to a RJ modular connector having a substrate provided therein to balance electrical couplings between terminals.

2. Description of the Related Art

RJ modular connector has been widely used in telecommunication system since it was firstly created. A so-called RJ45 modular connector has been widely used in the network system.

The RJ45 modular connector includes a total of eight terminals. Resulting from miniaturization of the computer, all corresponding components, including connectors, have to be reduced for their dimension and size. One of the negative consequences or problem created from miniaturization is electrical coupling between terminals. When the RJ connector is used in low speed signal transmission, the couplings between adjacent terminals can be ignored in light of its effect. However, when the RJ connector is used for high speed signal transmission, the couplings between adjacent terminals create a great problem. Unless the electrical coupling can be effectively controlled within an accepted level, it is unlikely that the RJ 45 modular connector can be used in the high-speed signal transmission.

One of the approaches is to select a pair of terminals as a differential pair. In the differential pair, two terminals transmit the same signal but with inverted phase. By this arrangement, the couplings coupled thereto can be finally subtracted in a data processing unit.

As shown in an attached catalog from The Siemon Company, there are at least eight different patterns in selecting terminals as differential pair, i.e. T568A, T568B, USOC 4-pair, USOC 1-, 2- or 3-pair, 10BASE-T (802.3), Token Ring (802.5), 3-pair (MMJ), and TP-PMD (X3T9.5) and ATM. In each implementation, two terminals are selected as a pair in which some are close to each other, while some are apart from each other. Each pattern has its own uniqueness, while each also carries with it a coupling issue to be addressed.

Among those patterns, T568A and T568B are widely used and in T568A, terminals 1, 2 configure 3^{rd} pair, terminals 3, 6 configure 2^{nd} pair, terminals 4, 5 configure 1^{st} pair while terminals 7, 8 configure 4^{th} pair. In T568B, terminals 1, 2 configure 2^{nd} pair, terminals 3, 6 configure 3^{rd} pair, terminals 4, 5 configure 1^{st} pair, while terminals 7, 8 configure 4^{th} pair.

Since those eight terminals are equally spaced, electrical couplings between terminals will surely create some problems, i.e. coupling or cross-talk. For example, if we take terminal 3 into consideration, terminal 3 will naturally pick up energy coupled from terminals 2 and 4 which are close to terminal 3. On the other hand, terminal 6, which carries signal having inverted phase of the signal carried by terminal 3, will also pick up energy coupled from terminals 5 and 7. However, energy coupled into terminals 3, 6 from terminals 2 and 7 can not be suitably eliminated because terminals 3, 6 is unlikely to establish couplings between terminal 1 and terminal 8 to balance the couplings between terminals 2, 3 and 6, 7. Accordingly, signals transmitted by terminals 3, 6 carry noises generated by their adjacent terminals 2, 7. In addition, terminals 3 and 6 will also carry noises coupled thereto from terminals 4, 5 and which couplings should be also carefully taken care of in order to avoid certain noises.

In order to decrease the effects of electrical coupling between the (3^{rd}, 4^{th}) and (3^{rd}, 2^{nd}) terminals, and (6^{th}, 5^{th}) and (6^{th}, 7^{th}) terminals, many approaches have been provided, such as creating electrical couplings between 3^{rd} and 1^{st} terminals and 3^{rd} and 5^{th} terminals to balance the electrical coupling between the 3^{rd} and 2^{nd} terminals and 3^{rd} and 4^{th} terminals, and creating electrical coupling between 6^{th} and 8^{th} terminals and 6^{th} and 4^{th} terminals to balance the electrical couplings between the 6^{th} and 7^{th} terminals and 6^{th} and 5^{th} terminals.

However, as mentioned above, those eight terminals are arranged in a common plane, it is impossible to create those balancing electrical couplings, i.e. (1^{st}, 3^{rd}), (3^{rd}, 5^{th}), and (4^{th}, 6^{th}), (6^{th}, 8^{th}) terminals when all terminals are located in the same level, it is unlikely to create any electrical channels therebetween to create those electrical couplings accordingly.

The Siemon Company, a US company, discloses a solution posted on the Internet, http://www.siemon.com/white_papers/99-08-30-through-hole.asp. A hard copy thereof is herein attached for reference.

As clearly shown in FIG. 4 of that reference, 6^{th} and 2^{nd} terminals are arranged in the first layer, while 8^{th}, 5^{th}, 4^{th}, and 1^{st} terminals are arranged in the second layer, and 7^{th} and 3^{rd} terminals are arranged in the third layer.

The 6^{th} terminal in the first layer has a rectangular loop having its longitudinal sides aligned with terminals 4^{th} and 8^{th} located in the second layer, while terminal 3 in the third layer also has a rectangular loop having its longitudinal sides aligned with terminals 5^{th} and 1^{st} located in the second layer.

In addition, the right longitudinal loop side of the terminal 6^{th} further includes a square corresponding to a square formed in terminal 4^{th}. The left longitudinal loop side of the terminal 3 includes also a square with respect to the square formed on terminal 8^{th}.

Arrangements suggested by Siemon are to increase the couplings between (1^{st}, 3^{rd}), (3^{rd}, 5^{th}), and (4^{th}, 6^{th}), (6^{th}, 8^{th}) terminals thereby helping to balance electrical couplings of the terminals.

However, those eight or four set sets of terminals are arranged in three different layers, and each set of terminals are separately divided by an insulative sheet material. This will no doubt increase the complexity of the connector.

In addition, there are five different shapes and configurations among those eight terminals. Each terminal has its own shape which is different from each other, especially the 3^{rd} and 6^{th} terminals, each including the rectangular loop portion which overlaps corresponding terminals to create desired electrical couplings. Each loop further forms the square to increase the electrical couplings with corresponding terminals having the square. The electrical couplings created can help to meet higher system requirement. The eight different configuration of the terminals will surely increase the difficulty and complexity in production.

There are some other approaches, including routing terminal tails of those 3^{rd}, 6^{th} and 4^{th}, 5^{th} terminals to alter their position and affect couplings between 3^{rd}, 2^{nd} and 3^{rd}, 4^{th}; and 6^{th}, 5^{th}, and 6^{th}, 7^{th} terminals. However routing terminal tails will inevitably increase the manufacturing cost.

U.S. Pat. No. 6,120,329, issued to Steinman on Sep. 19, 2000, discloses another approach to solve the above-addressed problem. Again, terminals are configured with different shapes and dimensions making the production complex.

U.S. Pat. No. 5,069,641 issued to Sakamoto et al. discloses a suggestion of using printed circuit board in the RJ modular housing, however, it addresses different issues.

### SUMMARY OF THE INVENTION

It is an object of this invention to provide an RJ modular connector, and more particularly to an RJ modular connector having a substrate with conductive traces provided therein to balance electrical couplings between terminals.

It is still an object of this invention to provide a RJ modular connector which can be easily manufactured.

In order to achieve the objective set forth, an RJ modular connector in accordance with the present invention comprises a housing defining a plug receiving section, and a terminal core receiving section. A terminal core is received in the terminal core receiving section and includes a plurality of terminals. A first and a second substrates are provided having first and second conductive traces thereon, respectively. The terminals are securely mounted onto the substrates. A first and a second electrical connections are established between a first and a second terminals and the first and second conductive traces, and a portion of each conductive trace is arranged to create a first and a second electrical couplings between the first and second terminals and a third and a fourth terminals, respectively. The third and the fourth terminals are arranged between the first and the second terminals and configure a differential pair located far from the first and the second terminals.

Other objects and further features of the present invention will be apparent from the following detailed description when read in conjunction with the accompanying drawings.

### BRIEF DESCRIPTION OF THE DRAWINGS

FIG. 1A is a perspective view of a RJ modular connector in accordance with the present invention;

FIG. 1B is a front view of FIG. 1A;

FIG. 1C is similar to FIG. 1A except viewed from a reverse direction;

FIG. 1D is a front view of FIG. 1C;

FIG. 1E is an exploded view of FIG. 1C;

FIG. 2A is a bottom view of a top substrate;

FIG. 2B is a top view of FIG. 2A;

FIG. 2C is a top view of a lower substrate;

FIG. 2D is a bottom view of FIG. 2C;

FIG. 3A is an exploded view of a terminal core in accordance with the present invention;

FIG. 3B is similar to FIG. 3A with terminals attached to the lower substrate;

FIG. 3C is an assembled perspective view of the terminal core;

FIG. 3D is another perspective view of the terminal core;

FIG. 3E is a cross sectional view of the terminal core; and

FIG. 3F is an exploded view of the terminal core with carrier attached thereto.

### DETAILED DESCRIPTION OF THE INVENTION

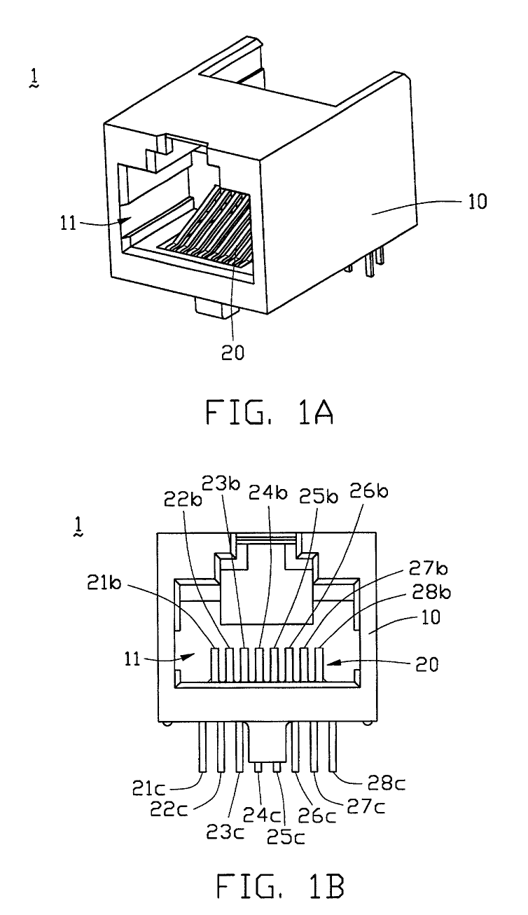

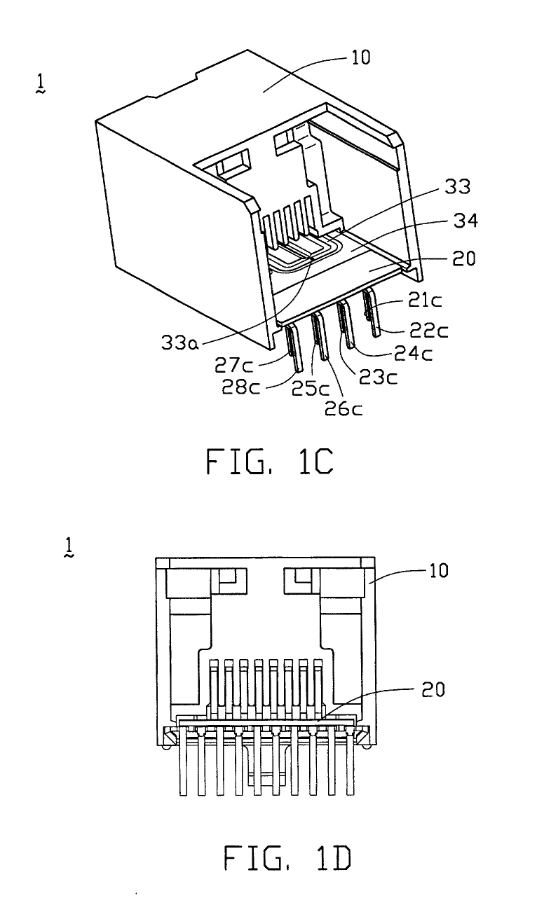

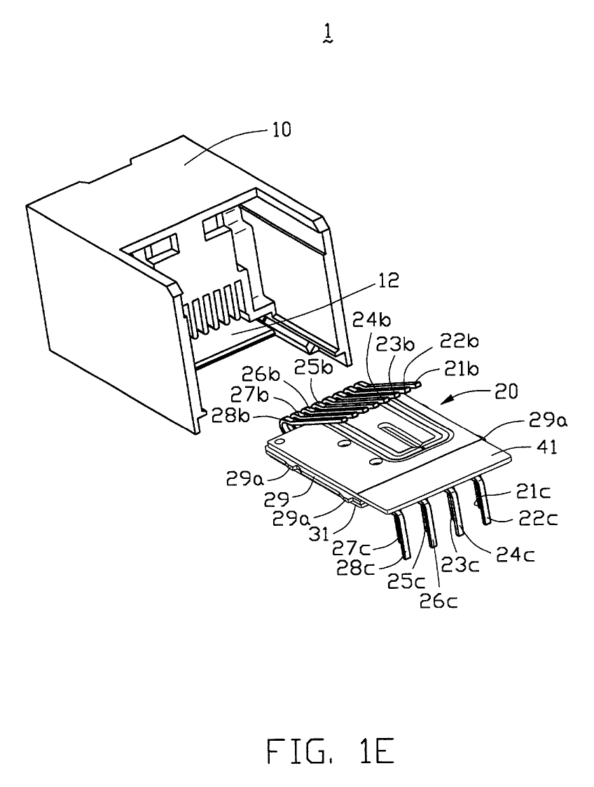

Referring to FIGS. 1A to 1E, a RJ modular connector 1 in accordance with the present invention includes a housing 10 defining a plug receiving space 11, and a terminal core receiving space 12 in which a modular terminal core 20 securely attached therein. The RJ modular connector 1 has a general dimension and shape corresponding to existing industry specifications. Accordingly, no details are given thereto. The unique feature of the present invention resides on providing the modular terminal core 20 which can be simply made in a cost-effective manner. In addition, the modular terminal core 20 is arranged such that electrical couplings can be created between selected terminals to balance electrical couplings between selected terminals. By this arrangement, cross-talk between certain terminals can be effectively eliminated or reduced.

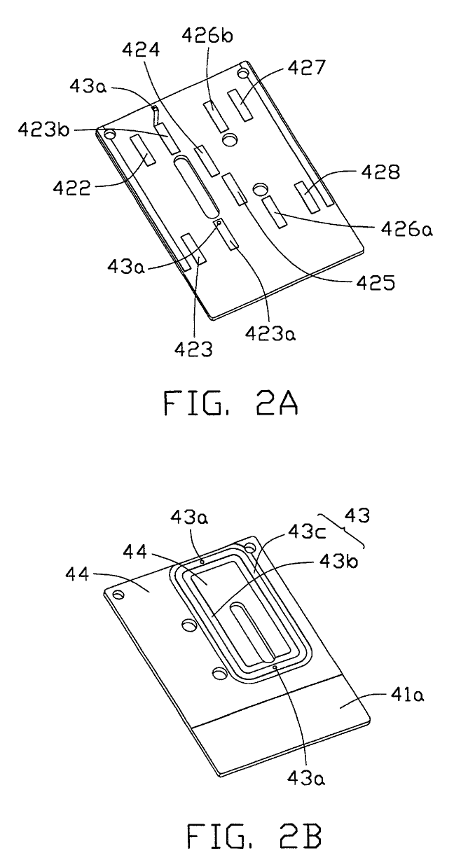

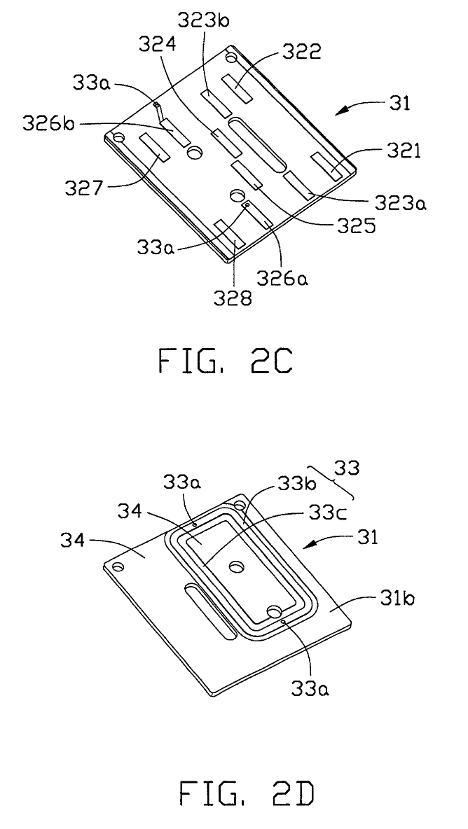

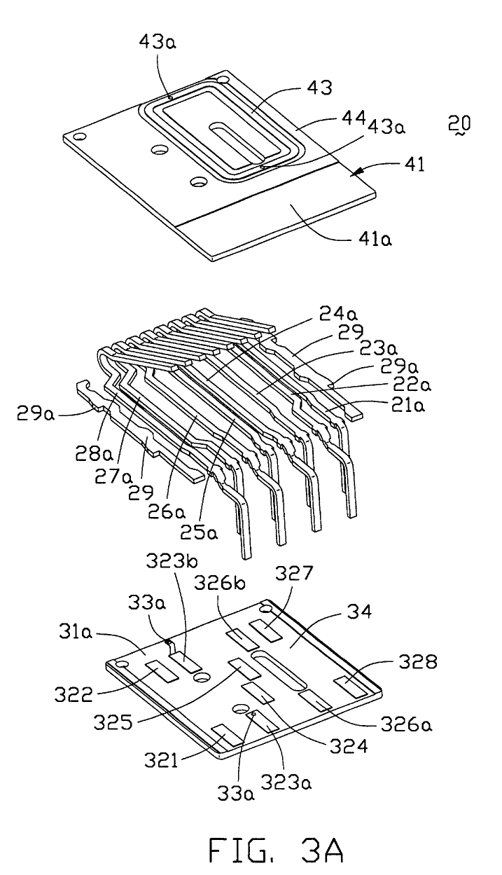

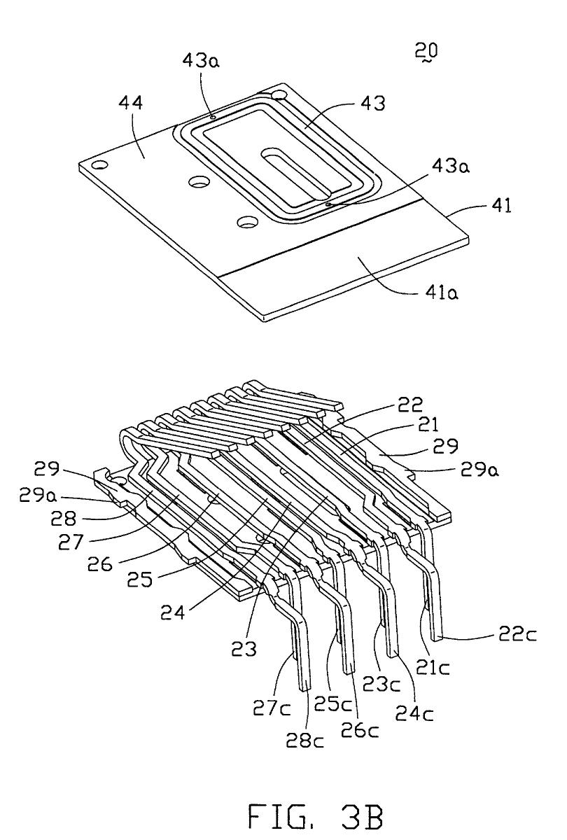

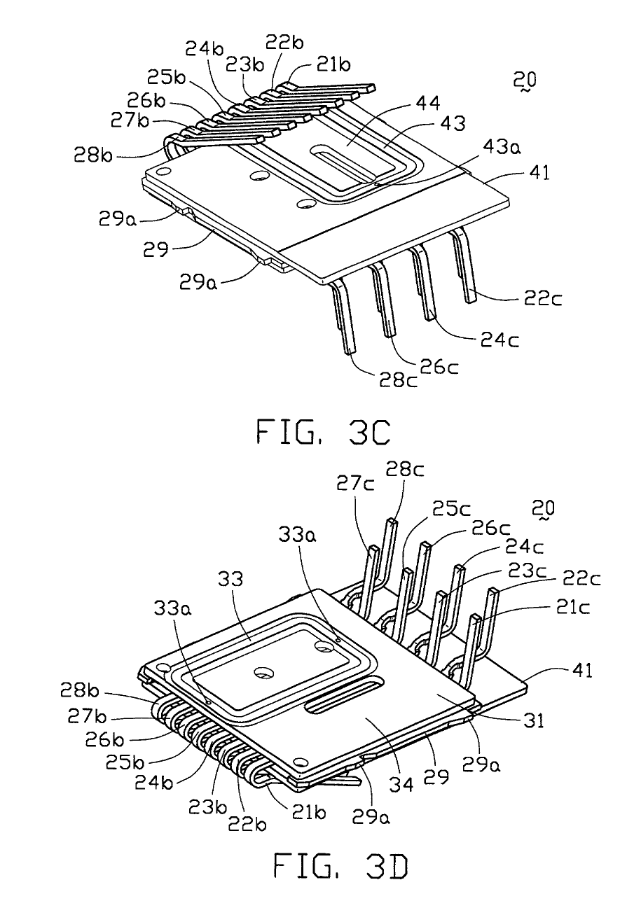

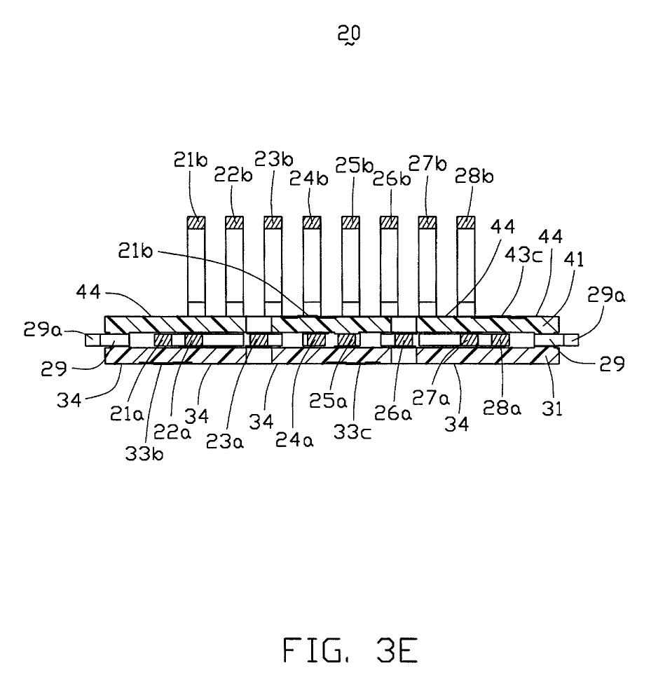

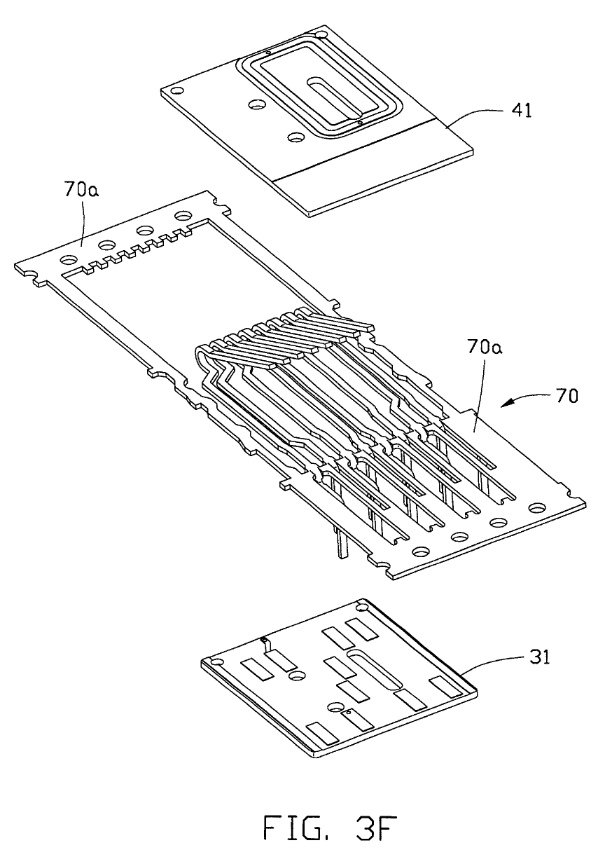

Referring to FIGS. 2A to 2D in conjunction with FIGS. 3A to 3F, the terminal core 20 in accordance with the present invention includes a plurality of terminals 21, 22, 23, 24, 25, 26, 27, and 28 and lower and upper or first and second printed circuit boards 31 and 41. The terminals 21, 22, 23, 24, 25, 27 and 28 respectively have contacting portions 21b, 22b, 23b, 24b, 25b, 26b, 27b, and 28b extending into the plug receiving space 11, leg portions 21c, 22c, 23c, 24c, 25c, 26c, 27c and 28c extending away from the housing 10, and connecting portions 21a, 22a, 23a, 24a, 25a, 26a, 27a and 28a connecting the contacting and leg portions 21b, 22b, 23b, 24b, 25b, 26b, 27b, and 28b and 21c, 22c, 23c, 24c, 25c, 26c, 27c and 28c and being sandwiched in a common plane between the lower and upper printed circuit boards 31, 41. Among the terminals, terminals 21, 22 configures a first pair, terminals 23, 26 configures a second pair, terminals 24, 25 configures a third pair, while terminals 27, 28 configures a fourth pair. The contacting portions 21b, 22b, 23b, 24b, 25b, 26b, 27b, and 28b are so formed as to be equally spaced from each other and the leg portions 21c, 22c, 23c, 24c, 25c, 26c, 27c and 28c are so configured as also to be equally spaced from each other, while the connecting portions 21a, 22a, 23a, 24a, 25a, 26a, 27a and 28a are differently configured so that the connecting portions 23a, 26a are located a little far from the adjacent connecting portions 22a and 24a, 25a and 27a whereby the terminal pairs 21a and 22a, 24a and 25a, and 27a and 28a are respectively closely arranged with respect to each other, thereby enhancing energy couplings and decreasing cross talk therebetween. In other words, in the present invention, the distance between the two connecting portions 21a and 22a, or 24a and 25a, or 27a and 28a, in the differential pair of the terminals 21 and 22, or 24 and 25, or 27 and 28, is smaller than the distance between the two connecting portions 22a and 23a, 23a and 24a, 25a and 26a, 26a and 27a.

The lower printed circuit board 31 defines first (top) and second (bottom) surfaces 31a, 31b and with conductive footprints or conductive pads 321, 322, 323, 324, 325, 326, 327 and 328 formed on the first face 31a. A conductive loop 33 is formed on the second face 31b and surrounded by a grounding plane 34. The conductive loop 33 is electrically connected to the conductive footprints 323 by means of tunnels 33a. Since the tunnel 33a is configured by a through-hole coated with conductive material, such as solder, and is known to the skill in the art, no details are given herebelow.

The upper printed circuit board 41 defines first (top) and second (bottom) surfaces 41a, 41b and with conductive footprints or conductive pads 421, 422, 423, 424, 425, 426, 427 and 428 formed on the second face 41b. A conductive loop 43 is formed on the first face 41a and surrounded by a grounding plane 44. The conductive loop 43 is electrically connected to the conductive footprints 426 by means of tunnels 43a which is identical to the tunnels 33a.

Among the footprints 321, 322, 323, 324, 325, 326, 327 and 328, the footprint 323 corresponding to terminal 23 includes first and second portions 323a, 323b; while footprint 326 with respect to terminal 26 includes also first and second portions 326a, 326b. Among the footprints 421, 422, 423, 424, 425, 426, 427 and 428, the footprint 426 with respect to the terminal 26 includes first and second portions 426a, 426b; while footprint 423 with respect to the terminal 23 includes also first and second portions 423a, 423b.

The connecting portions 21a, 22a, 23a, 24a, 25a, 26a, 27a, and 28a of the terminals 21, 22, 23, 24, 25, 26, 27, and 28 can be securely sandwiched between the printed circuit boards 31, 41 by applying solder pastes on the footprints 321, 322, 323, 324, 325, 326, 327 and 328 and the footprints 421, 422, 423, 424, 425, 426, 427 and 428, and then reflowing the solder pastes such that the terminals 21, 22, 23, 24, 25, 26, 27, and 28 are completely and securely attached to the footprints 321, 322, 323, 324, 325, 326, 327 and 328 of the lower printed circuit board 31; and footprints 421, 422, 423, 424, 425, 426, 427 and 428 of the upper printed circuit board 41.

As clearly shown in FIGS. 2B, 2D and 3E, the conductive trace 33 formed on the bottom (second) face of the first substrate 31 includes first and second portions 33b, 33c which are aligned with terminals 21 and 25, while the conductive trace 43 formed on upper (first) face of the substrate 41 includes first and second portions 43b, 43c which are aligned with terminals 24 and 28. Accordingly, electrical couplings will be generated between the first portion 33b and the terminal 21, and the second portion 33c and the terminal 25. By the same reason, electrical couplings will be generated between the first portion 43b and the terminal 24, and the second portion 43c and the terminal 28. On the other hand, since the connecting portions 23a and 26a are respectively located far from the connecting portions 24a and 25a, the second portion 33c and the first portion 43b would add little influence on signal transmission of the terminals 26 and 23. However, if the connecting portions 21a, 22a, 23, 24a, 25a, 26a, 27a and 28a are equally spaced from each other, due to the closeness therebetween, the second portion 33c and the first portion 43b, while as desired are coupled to the terminals 25 and 24, respectively, are more or less coupled unwantedly to the terminals 26 and 23, which adversely affects couplings between the terminals 23 and 26 and increases cross talk therebetween.

As can be readily appreciated, the electrical coupling between the third terminal 23 and the first terminal 21 by means of the conductive trace 33 (via first portion 33b) will properly help to balance the electrical coupling between the third terminal 23 and the second terminal 22. While, the electrical coupling between the sixth terminal 26 and the eighth terminal 28 by means of the conductive trace 43 (via second portion 43c) will also properly help to balance the electrical coupling between the sixth terminal 26 and the seventh terminal 27. As a result, the energy coupled into terminals 23, 26 from terminals 22, 27 can be more properly balanced by the introduction of the electrical couplings between the terminals 23, 26 with respect to the terminals 21 and 28, respectively. As a result, the signal transmitted through the differential pair terminals 23, 26 benefits from balanced coupling from its adjacent terminals, such as terminals 22 and 27. Furthermore, due to the unique arrangement of the connecting portions 21a, 22a, 23a, 24a, 25a, 26a, 27a, and 28a, the terminals 21 and 22, 24 and 25, 27 and 28 in each differential pair are more closely located than when the eight terminals as usually are equally spaced from one another, thereby enhancing coupling and decreasing cross talk therebetween. As to the differential pair of the terminals 23 and 26, since they are located relatively fartherly from adjacent terminals 22, 24, 25 and 27 and in turn are located fartherly from the second portion 33c and the first portion 43b of the conductive traces 33 and 43 than those conventional equally spaced terminals, they are minimally affected by adjacent terminals and the conductive traces and the coupling between them are ensured, thereby guaranteeing high speed signal transmission in the two terminals 23, 26.

As can be readily seen from FIG. 3F, the manufacturing of the terminal core 20 is comparatively simple as compared to the prior art in which the terminals 21 to 28 are integrally molded or assembled together. In the present invention, the terminals 21 to 28 can be simply stamped from a sheet metal 70. Then the terminals 21 to 28 can be easily sandwiched by the first and second substrate 31, 41. The carrier 70a can be simply trimmed off after the terminals 21 to 28 are securely attached and sandwiched between the first and second substrates 31 and 41.

In addition, it can be readily appreciated that during the stamping of the terminals 21 to 28, retaining beam 29 having barbs 29a can be also formed on the sheet metal 70 and which are also attached and sandwiched between the first and second substrates 31 and 41 by solder. Accordingly, the terminal core 20 resulted therefrom can be easily inserted into the terminal core receiving space 11 and securely attached therein by the barbs 29a.

Even the above embodiment uses patterns of T568A and T568B to illustrate the spirit of the present invention, it can be readily appreciated that coupling issues from other patterns, such as 3-Pair MMJ, USOC 4-pair, and TP-PMD (X3T9.5) and ATM can also be helped out by the teaching of the present invention without creating complex configuration of the terminals. By the teaching of the present invention, the terminals can be made as simple as existing terminals, while the coupling issue can be taken care by the printed circuit board.

Even the present invention illustrates its best mode of embodiments by establishing electrical couplings between conductive loops and corresponding terminals, it can be readily appreciated that the electrical couplings can be also created via conductive loops and conductive pads on which terminals are electrically connected thereto, i.e. terminal heads and tails are connected to the conductive pads extending through a substrate, while the conductive loop and the conductive pads are arranged to create electrical coupling to balance electrical couplings among terminals.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

I claim:

1. A RJ modular connector, comprising:
a housing defining a plug receiving section and a terminal core receiving section; and
a terminal core received in the terminal core receiving section, the terminal core comprising:
a first and a second substrates each having conductive pads formed on one surface thereof and a first and a second conductive traces on another opposite surface thereof, each of the first and the second conductive traces having a first and a second portions; and
a plurality of terminals attached to the conductive pads and each comprising a connecting portion, a first and a second terminals of the plurality of terminals respectively electrically connecting with the first and the second conductive traces, four selected terminals of the plurality of terminals other than the first and second terminals electrically coupling with the first and the second portions of the first and the second substrates, the connecting portion of the first terminal being located adjacent to and far from the connecting portion of one of the four selected terminals which couples with the second conductive trace.

2. The RJ modular connector as recited in claim 1, wherein the connecting portions of the terminals are located in a common plane and are sandwiched between the first and second substrates.

3. The RJ modular connector as recited in claim 2, wherein the terminals each comprise a contacting portion extending into the plug receiving section, a leg portion extending away from the housing, and the connecting portion connecting the contacting and the leg portions.

4. The RJ modular connector as recited in claim 1, wherein the conductive traces are spaced from the terminals by a thickness of the first and the second substrates.

5. A RJ modular connector, comprising:
a housing defining a plug receiving section, and a terminal core receiving section;
a terminal core received in said terminal core receiving section and including a plurality of terminals;
a first substrate having a first conductive trace thereon, an electrical connection being established between a first terminal of the plurality of terminals and the first conductive trace, a portion of the first conductive trace being arranged to create a first electrical coupling between the first terminal and a second terminal of the plurality of terminals to balance a second electrical coupling between the first terminal and a third terminal of the plurality of terminals arranged between the first and the second terminals; and
a second substrate having a second conductive trace thereon, an electrical connection being established between a fourth terminal of the plurality of terminals and the second conductive trace, a portion of the second conductive trace being arranged to create a third electrical coupling between the fourth terminal and a fifth terminal of the plurality of terminals to balance a fourth electrical coupling between the fourth terminal and a sixth terminal of the plurality of terminals arrange between the fourth and the fifth terminals, wherein
the terminals each comprise a connecting portion sandwiched between the first and the second substrates, and the connecting portion of the second terminal is located adjacent to and far from the connecting portion of the fourth terminal.

6. The RJ modular connector as recited in claim 5, wherein the connecting portions of the first, second, third, fourth, fifth and sixth terminals are arranged in a common plane.

7. The RJ modular connector as recited in claim 6, wherein a portion of each conductive trace is parallel to the connecting portions of the first to sixth terminals.

8. The RJ modular connector as recited in claim 7, wherein the second terminal electrically couples with and is located close to the third terminal.

9. The RJ modular connector as recited in claim 7, wherein the fifth terminal electrically couples with and is located close to the sixth terminal.

10. The RJ modular connector as recited in claim 7, wherein the first terminal electrically couples with the fourth terminal.

11. The RJ modular connector as recited in claim 7 further comprising a seventh terminal and a eighth terminal electrically coupling with the seventh terminal, wherein the seventh terminal is arranged between the eighth and the first terminals and is located far from the first terminal but close to the eighth terminal.

12. A RJ modular connector comprising:
a housing defining a plug receiving section and a terminal core receiving section; and
a terminal core received in the terminal core receiving section and comprising:
a first and a second substrates forming a first and a second conductive traces thereon, respectively; and
a first through fourth terminals attached to the first and the second substrates, the first and the second terminals electrically connecting with the first and the second conductive traces, respectively, the third and the fourth terminals electrically coupling with a first and a second portions of the first and the second conductive traces, respectively and being located between the first and the second terminals, the third terminal electrically coupling with the fourth terminal, the third and the fourth terminals being located adjacent to and far from the first and the second terminals, respectively.

13. An electrical connector comprising:
an insulative housing defining a mating port;
a terminal core received in the housing communicating with said mating port, said terminal core comprising:
at least one substrate forming a conductive trace thereon;
a plurality of terminals each with a slanted contacting portion, a vertical leg portion and a horizontal connection portion therebetween, all of said horizontal connection portions positioned upon said substrate, wherein
the connection portion of a first one of said terminals is spaced from that of one neighboring second terminal with a larger distance in comparison with those between other adjacent two neighboring terminals for reducing crosstalk therebetween, and the connection portion of said first terminal engages said conductive trace extending toward and close to a third terminal which is another neighboring one of said second terminal opposite to said first terminal to induce additional crosstalk to the first terminal for counterbalancing the crosstalk between said first and second terminals to the first terminal.
